(19) United States
(12) Patent Application Publication
(10) Pub. No.: US 2016/0134968 A1
(43) Pub. Date: May 12, 2016

(54) VEHICLE MULTIMEDIA SYSTEM AND METHOD

(71) Applicant: HON HAI PRECISION INDUSTRY CO., LTD., New Taipei (TW)

(72) Inventor: MENG-YU CHUNG, New Taipei (TW)

(21) Appl. No.: 14/543,245

(22) Filed: Nov. 17, 2014

(30) Foreign Application Priority Data
Nov. 7, 2014 (TW) 103138629

(51) Int. Cl. H04R 3/00; H04N 21/439; H04N 21/422; H04N 21/414

(52) U.S. Cl. CPC H04R 3/002; H04N 21/41422; H04N 21/439; H04N 21/42203; H04R 2499/13

(57) ABSTRACT

A vehicle multimedia system able to provide for optimal performance in the vehicle in which it is installed includes a microphone, a signal processing module, a multimedia control module, an audio output device, and a video control signal. The microphone records environmental noise inside a vehicle. The signal processing module receives the environmental noise signal and makes a noise cancellation signal. The multimedia control module receives a video signal, an audio signal, and the noise cancellation signal. The audio signal is combined with the noise cancellation signal to produce a clean audio signal. The multimedia control module outputs the clean audio signal to one or more audio output devices and outputs the video signal video to one or more video output devices.

### FIELD

The subject matter herein generally relates to a in-vehicle multimedia.

### BACKGROUND

Speakers are usually arranged around seating locations in a vehicle. This kind of speaker arrangement provides an audio environment for all passengers. Under a traditional surround audio environment, the speaker arrangement may cause audio signal distortion and degradation of audio performance.

### BRIEF DESCRIPTION OF THE DRAWINGS

Implementations of the present technology will now be described, by way of example only, with reference to the attached figures.

FIG. 1 is a diagrammatic view of a vehicle multimedia system coupled to an outside signal device.

FIG. 2 is another diagrammatic view of a vehicle multimedia system coupled to an outside signal device.

FIG. 3 illustrates an embodiment of a seat headrest of the vehicle multimedia system of FIG. 1.

FIG. 4 illustrates an embodiment of the vehicle multimedia system set up in a vehicle.

FIG. 5 is a flow diagram illustrating a method of operating a vehicle multimedia system.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is in relation to a vehicle multimedia system. The vehicle multimedia system provides multiple audio and video outputs for passengers.

The vehicle multimedia system includes a microphone, a signal processing module, a multimedia control module, an audio output device, and a video control signal. The microphone is configured to record environmental noise inside a vehicle. The signal processing module is configured to receive the signal representing the environmental noise and output a signal to effectively cancel the environmental noise (noise cancellation signal). The multimedia control module is configured to receive a video signal, an audio signal, and the noise cancellation signal. The audio signal is combined with the noise cancellation signal to produce an audibly clean audio signal (clean audio signal). The multimedia control module is configured to output the clean audio signal to an audio output device coupled to the multimedia control module. The multimedia control module is configured to output the video signal video to a video output device coupled to the multimedia control module. The control unit is coupled to a multimedia control module and configured to receive an audio control signal and a video control signal. The audio control signal can control which audio output device is to output the clean audio signal and which video output device is to output the video signal.

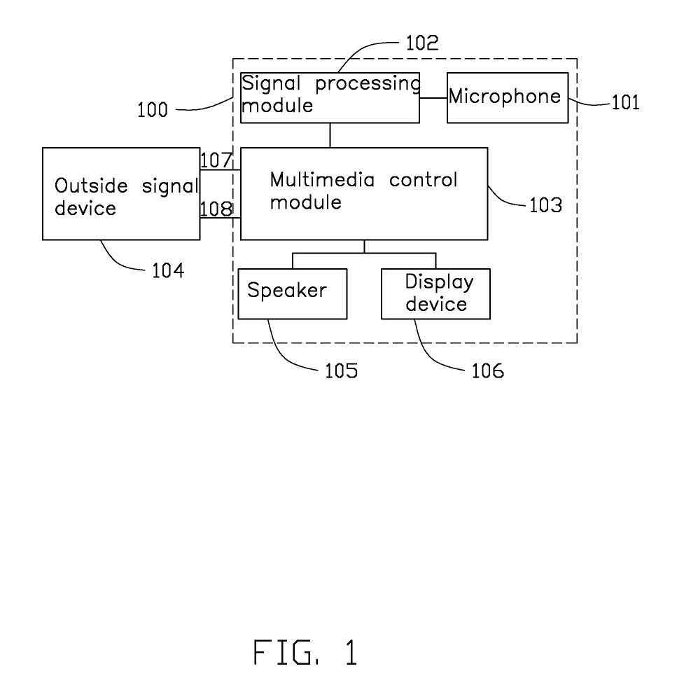

FIG. 1 illustrates an embodiment of a vehicle multimedia system 100, which includes a microphone 101. The microphone 101 can record environmental noise in the vehicle. The environmental noise may be produced by operations of the vehicle, noises outside the vehicle, or noises inside the vehicle. For example, the noises may be from an engine, the winds, road rumble, or passengers talking inside the vehicle. After the environmental noise is recorded by the microphone 101, the microphone 101 transmits the environmental noise to a signal processing module.

The signal processing module 102 can be a micro processor, an electric circuit, or a software implementation which can implement digital signal processing (DSP). After receiving an environmental noise signal representing the environmental noise from the microphone 101, the signal processing module 102 can make a noise cancellation signal to offset the environmental noise. Then the signal processing module 102 transmits the noise cancellation signal to a multimedia control module 103.

An audio signal is transmitted via an audio signal line 107 from an outside signal device 104 to the multimedia control module 103. The outside signal device 104 may be a cell phone, a tablet, a laptop, a vehicle computer, an audio apparatus, an MP3 player, a DVD player, a broadcasting system, or an advanced driving assistance system. The multimedia control module 103 combines the audio signal with the noise cancellation signal to make a clean audio signal. Then the clean audio signal is transmitted to a speaker 105 to be played. The noise cancellation signal which is inherent in the clean audio signal can balance the environmental noise in order to provide clear sound and better performance of a stereo audio for passengers in the vehicle.

A video signal is transmitted via a video signal line 108 from an outside signal device 104 to the multimedia control module 103. The outside signal device 104 may be a cell phone, a tablet, a laptop, a vehicle computer, an audio apparatus, an MP3 player, a DVD player, a broadcasting system, or an advanced driving assistance system. The multimedia control module 103 is coupled to a display device 106. The display device 106 is configured to receive the video signal from the outside signal device 104 and show the video on the display device.

The multimedia control module 103 and outside signal device 104 can be wired or wirelessly connected through the audio signal line 107 and the video signal line 108.

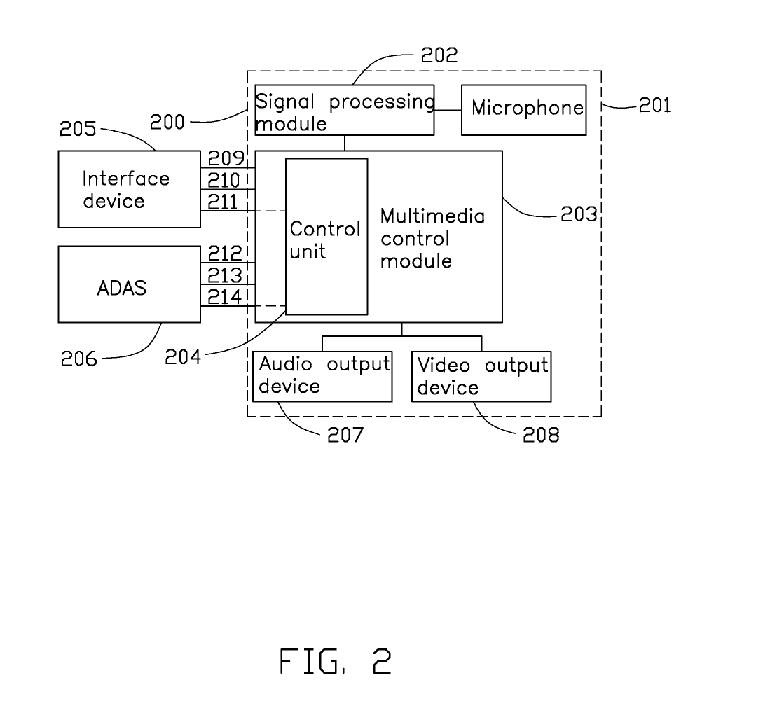

FIG. 2 illustrates an embodiment of a vehicle multimedia system 200. A control unit 204 is coupled to a multimedia control module 203 and configured to select and control an audio output device and a video output device. The control unit 204 can receive a first control signal from an interface device 205 through a first control line 211 and receive a second control signal from an advanced driving assistance system 206 (ADAS 206) through a second control line 214. The interface device may be a cell phone, a tablet, a laptop, a vehicle computer, an audio apparatus, an MP3 player, a DVD player, or a broadcasting system. The ADAS 206 may be a “Vehicle Warning System”, a “Blind Spot Detection System”, a “Parking Aid System”, a “Crash Collision Warning System”, a “Lane Departure Warning System”, a “Collision Mitigation System”, an “Adaptive Front-lighting System”, a “Night Vision System”, a “Cruise Control System”, or a “Pre Crash System”.

Based on the first control signal from the interface device 205, the control unit 204 selects and controls at least one audio output device 207, such as by volume level, sound stereo effects, or inputs to specific speakers. The first control signal also can select and control at least one video output device 208 in relation to brightness of a display device, contrast of the display device, or inputs to specific display devices.

The interface device 205 further can transmit a first audio signal to the multimedia control module 203 through a first audio signal line 209 and transmit a first video signal to the multimedia control module 203 through a first video signal line 210.

Based on the second signal from the ADAS 206, the control unit 204 selects and controls at least one audio output device 207, such as by controlling sound volume, sound stereo effects, or inputs to specific speakers. The second control signal also can select and control at least one video output device 208, for example, controlling brightness of a display device, contrast of the display device, or inputs to specific display devices.

The ADAS 206 further can transmit a second audio signal to the multimedia control module 203 through a second audio signal line 212 and transmit a second video signal to the multimedia control module 203 through a second video signal line 213.

For example, when an occupant does not fasten his seat belt, the ADAS 206 would give a warning event to the multimedia control module 203. The warning event can be divided into three signals: a warning audio signal, a warning video signal, and a warning control signal. The warning audio signal is transmitted through the second audio signal line 212 to the multimedia control module 203 and combined with the clean audio signal. The warning video signal is transmitted through the second video signal line 213 to the multimedia control module 203. The warning control signal is transmitted through the second control line 214 to the control unit 204. The control unit 204 can control the output of the clean audio signal and the warning video signal containing the warning to a particular speaker and a particular display device. According to this example, the clean audio signal containing the warning can be produced via a speaker inside the driver's seat headrest and displayed via a display device which is visible to the driver so that other passengers in the vehicle are not disturbed.

The first audio signal line 209, the first video signal line 210, and the first control line 211 can have a wired or a wireless connection between multimedia control module 203 and the interface device 205. The second audio signal line 212, the second video signal line 213, and the second control line 214 can be wired or wirelessly connected between multimedia control module 203 and the ADAS 206.

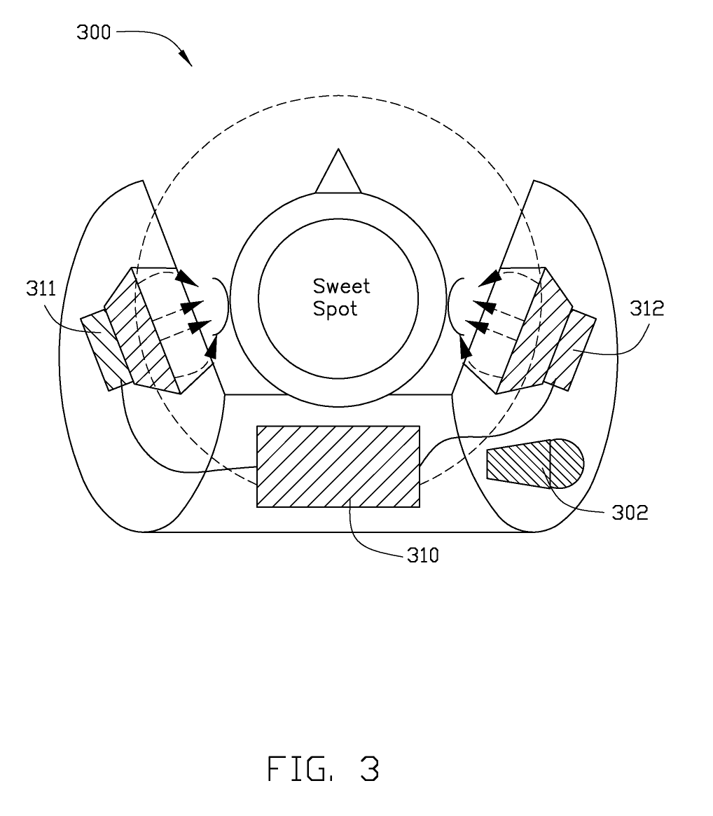

FIG. 3 illustrates an embodiment of a seat headrest 300 arrangement in a vehicle. The seat headrest includes a two-channel speaker 310. The two-channel speaker further includes left a speaker 311 and a right speaker 312. The seat headrest further has a microphone 301 which is configured to record environmental noise. The noise cancellation signal and an audio signal would be integrated and regenerated into a clean audio signal via a vehicle multimedia system. The two-channel speaker 310 can play the clean audio signal with a higher quality of audio playback because the environmental noise is effectively decreased, and stereo surround effects as well as a sweet spot are provided by left the speaker 311 and the right speaker 312. According to the embodiment from FIG. 1 and FIG. 2, the two-channel speaker 310 can also provide information independently to the driver and to each passenger. The seat headrest 300 can create a personal entertainment environment without disturbance to other passengers in the vehicle and with environmental noises nullified.

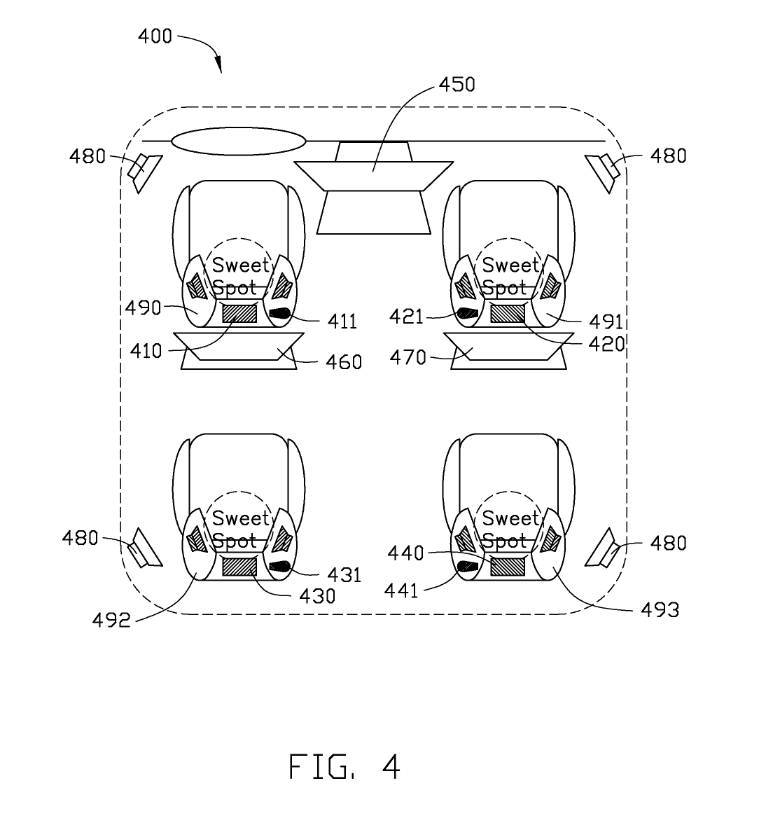

FIG. 4 illustrates an embodiment of a vehicle multimedia system set up in a vehicle 400. A driver seat headrest 490 includes a driver speaker 410 and a driver microphone 411. A first seat headrest 491 has a first speaker 420 and a first microphone 421. A second seat headrest 492 has a second speaker 430 and a second microphone 431. A third seat headrest 493 has a third speaker 440 and a third microphone 441. A driver and a first passenger share a first display device 450. A second passenger watches a second display device 460. A third passenger watches a third display device 470. According to the above arrangement of speakers and display devices, the driver and the passengers all have their own sweet spots centered on them.

An ADAS 206 also can provide some early warning or suggestion based on a vehicle condition, to the driver or the passengers. For example, the ADAS 206 might generate a warning event when the driver appears sleepy. The vehicle multimedia system receives the warning event from the ADAS 206 and transmits a specific signal to the driver speaker 410 to stimulate the driver. The vehicle multimedia system at the same time also transmits another specific audio signal to the first speaker 420, the second speaker 430, and the third speaker 440, transmitting another specific video signal to the first display device 450, the second display device 460, and third display device 470 in order to warn the passengers that the driver may be drowsy.

According to another aspect of the embodiment, the driver and the passengers can communicate through the vehicle multimedia system. For example, the driver can use the driver microphone 411 to deliver a voice message to the first passenger, the second passenger, and the third passenger, wherein the voice message can be played by the first speaker 420, the second speaker 430, and the third speaker 440.

According to another aspect of the embodiment, the driver speaker 410, the first speaker 420, the second speaker 430, and the third speaker 440 can be switched to the vehicle speakers 480.

According to another aspect of the embodiment, the driver seat headrest 490, the first seat headrest 491, the second seat headrest 492, and the third seat headrest 493 have position sensors which can detect the respective head positions of the passengers. The respective sweet spots of the driver speaker 410, the first speaker 420, the second speaker 430, and the third speaker 440 can be adjusted based on head position of a seat occupant.

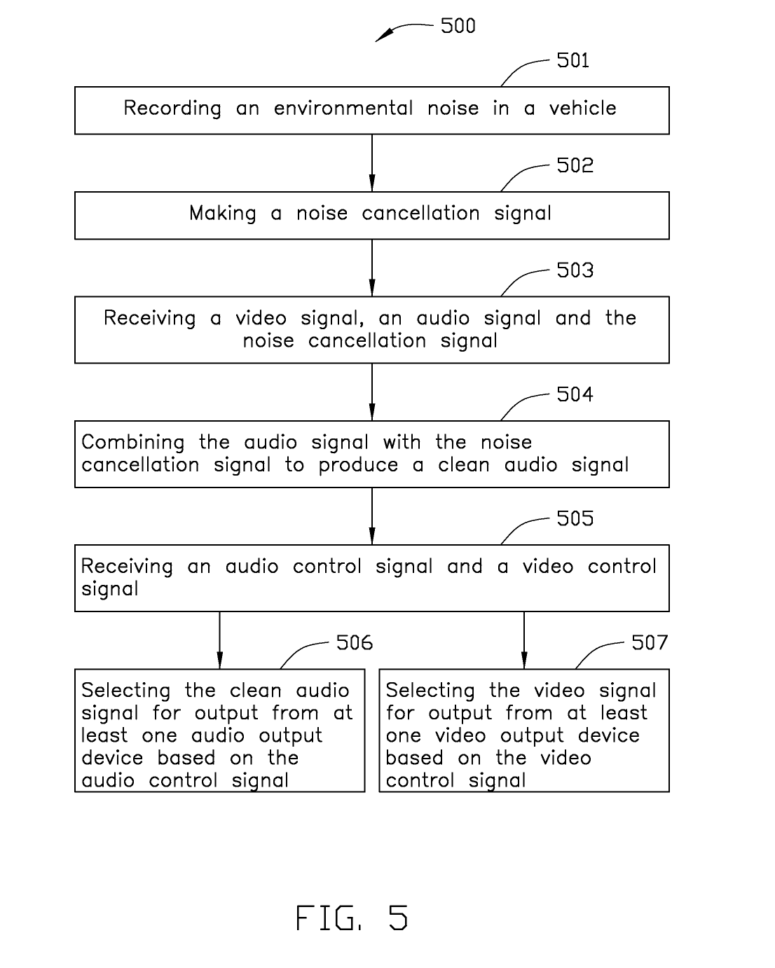

FIG. 5 illustrates a method 500 of an operation of a vehicle multimedia system. At block 501, an environmental noise in a vehicle is recorded. At block 502, a noise cancellation signal is created in order to offset the environmental noise. At block 503, a video signal, an audio signal, and the noise cancellation signal are received. The video signal and the audio signal can be from an outside signal device coupled to the vehicle multimedia system or from a device integrally installed in the vehicle multimedia system. At block 504, the audio signal is combined with the noise cancellation signal to produce a clean audio signal. At block 505, an audio control signal and a video control signal are received. At block 506, the clean audio signal is selected for output from at least one audio output device based on the audio control signal. The audio output device may be speakers, earphones, or headphones. At block 507, the video signal is selected for output from at least one video output device based on the video control signal.

The embodiments shown and described above are only examples. Many details are often found in the art such as the other features of a vehicle multimedia system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A vehicle multimedia system comprising:
a microphone configured to record an environmental noise inside a vehicle;
a signal processing module configured to receive an environmental noise signal representing the environmental noise and to output a noise cancellation signal;
a multimedia control module configured to receive a video signal, an audio signal and the noise cancellation signal, wherein
the audio signal is combined with the noise cancellation signal to produce a clean audio signal, and the multimedia control module is configured to output the clean audio signal to at least one audio output device which is coupled to the multimedia control module and to output the video signal video to at least one video output device coupled to the multimedia control module; and
a control unit coupled to a multimedia control module and configured to receive an audio control signal and a video control signal, wherein
the audio control signal can control which audio output device to output the clean audio signal, and which video output device to output the video signal.

2. The vehicle multimedia system of claim 1, wherein the audio output device is selected from at least one of plurality of speakers in the vehicle, and the video output device is selected from at least one of plurality of display devices in the vehicle.

3. The vehicle multimedia system of claim 2, wherein the speakers are located in at least one of plurality of seat headrests.

4. The vehicle multimedia system of claim 2, wherein the speakers are located around seating location of the vehicle.

5. The vehicle multimedia system of claim 1, wherein the video signal, the audio signal the audio control signal and the video control signal are from an outside signal device.

6. The vehicle multimedia system of claim 5, wherein the outside signal device is an interface device.

7. The vehicle multimedia system of claim 5, wherein the outside signal device is an advanced driving assistance system.

8. The vehicle multimedia system of claim 2, wherein the seat headrests have position sensors which can detect head position of passengers.

9. The vehicle multimedia system of claim 1, wherein a driver and passengers can communicate through the microphone.

10. A method of controlling vehicle multimedia system, the method comprising:
recording an environmental noise in a vehicle;
making a noise cancellation signal in order to offset the environmental noise;
receiving a video signal, an audio signal and the noise cancellation signal;
combining the audio signal with the noise cancellation signal to produce a clean audio signal;
receiving an audio control signal and a video control signal;
selecting the clean audio signal for output from at least one audio output device based on the audio control signal; and
selecting the video signal for output from at least one video output device based on the video control signal.

11. The method of claim 10, wherein the audio output device is selected from at least one of plurality of speakers in the vehicle, and the video output device is selected from at least one of plurality of display devices in the vehicle.

12. The method of claim 11, wherein the speakers are located in at least one of plurality of seat headrests.

13. The method of claim 11, wherein the speakers are located around seating location of the vehicle.

14. The method of claim 10, wherein the audio control signal and the video control signal are from an outside signal device.

15. The method of claim 14, wherein the outside signal device is an interface device.

16. The method of claim 14, wherein the outside signal device is an advanced driving assistance system.

17. A vehicle having a vehicle multimedia system comprising, the vehicle multimedia system comprising:
a microphone configured to record an environmental noise inside a vehicle;
a signal processing module configured to receive an environmental noise signal representing the environmental noise and to output a noise cancellation signal;
a multimedia control module configured to receive a video signal, an audio signal and the noise cancellation signal, wherein
the audio signal is combined with the noise cancellation signal to produce a clean audio signal, and the multimedia control module is configured to output the clean audio signal to at least one audio output device which is coupled to the multimedia control module and to output the video signal video to at least one video output device coupled to the multimedia control module; and
a control unit coupled to a multimedia control module and configured to receive an audio control signal and a video control signal, wherein
the audio control signal can control which audio output device to output the clean audio signal, and which video output device to output the video signal.

18. The vehicle having a vehicle multimedia system of claim 17, wherein the audio output device is selected from at least one of plurality of speakers in the vehicle, and the video output device is selected from at least one of plurality of display devices in the vehicle.

19. The vehicle having a vehicle multimedia system of claim 17, wherein the audio control signal and the video control signal are from an outside signal device.

20. The vehicle having a vehicle multimedia system of claim 19, wherein the outside signal device is an interface device.
